(19) United States
(12) Patent Application Publication
(10) Pub. No.: US 2018/0298470 A1
(43) Pub. Date: Oct. 18, 2018

(54) NICKEL-BASE ALLOY, TURBINE BLADE, AND METHOD FOR PRODUCING INJECTION MOLDED ARTICLE OF NICKEL-BASE ALLOY

(71) Applicant: MITSUBISHI HEAVY INDUSTRIES AERO ENGINES, LTD., Aichi (JP)

(72) Inventors: Kenji SUZUKI, Tokyo (JP); Kentaro SHINDO, Tokyo (JP); Shuntaro TERAUCHI, Osaka (JP); Hisashi KITAGAKI, Osaka (JP); Kazuki HANAMI, Osaka (JP); Tadayuki HANADA, Aichi (JP)

(21) Appl. No.: 15/781,506

(22) PCT Filed: Mar. 16, 2017
(86) PCT No.: PCT/JP2017/010781

§ 371 Date: Jun. 5, 2018

(30) Foreign Application Priority Data
Apr. 5, 2016 (JP) 2016-075933

(51) Int. Cl. C22C 19/05; B22F 3/24; B22F 3/22; B22F 9/08; C22C 1/04; F01D 5/28

(52) U.S. Cl. CPC C22C 19/056; B22F 3/24; B22F 3/225; B22F 9/082; C22C 1/0433; F01D 5/28; F05D 2300/226; B22F 2301/15; B22F 2302/10; F05D 2300/175; F05D 2300/608; F05D 2230/50; B22F 2003/248

(57) ABSTRACT

Provided are a nickel-base alloy having high high-temperature strength, a turbine blade using same, and a method for producing an injection molded article of the nickel-base alloy. The nickel-base alloy contains: at least one metal element from among chrome, molybdenum, and niobium; nickel; aluminum; and carbon. The nickel-base alloy comprises a plurality of crystal grains and a plurality of precipitates. The areas between the individual crystal grains in the nickel-base alloy, i.e., the boundaries of the individual crystal grains serve as crystal grain boundaries. The crystal grains are crystals in which nickel is the primary component. The precipitates are precipitated on the crystal grain boundaries. The precipitates are carbides comprising: at least one metal element from among chrome, molybdenum, and niobium; and carbon. The carbides have a diameter of 0.1-10 μm and an aspect ratio of 3 or more.

### TECHNICAL FIELD

The present invention relates to a nickel-base alloy, a turbine blade, and a method for producing an injection molded article of a nickel-base alloy.

### BACKGROUND ART

For some of members that are used in high-temperature environments, for example, turbine blades in gas turbines such as aircraft engines or motors or turbine blades that are used in turbochargers, nickel-base alloys containing nickel as a primary component are used. An example of the nickel-base alloy is a nickel-base alloy containing aluminum. As the nickel-base alloy containing aluminum, there is a precipitation hardening-type nickel-base alloy having a structure in which the alloy-phase particles of Ni₃Al (trinickel aluminide), which are referred to as γ prime precipitates, are precipitated. The precipitation hardening-type nickel-base alloy has a high strength at a high temperature. PTL 1 describes a method for producing a precipitation hardening-type nickel-base alloy in which the precipitation state of γ prime precipitates is controlled by carrying out a predetermined treatment such as a thermal treatment.

### CITATION LIST

### Patent Literature

[PTL 1] Japanese Unexamined Patent Application Publication No. 58-37382

### SUMMARY OF INVENTION

### Technical Problem

However, in the method described in PTL 1, in a case in which a long time is taken for production, there is a case in which limitation is caused for production, and the high-temperature strength of nickel-base alloys to be produced is not sufficient in some cases.

The present invention has been made in consideration of what has been described above, and an object of the present invention is to provide a nickel-base alloy having high high-temperature strength, a turbine blade using the same, and a method for producing an injection molded article of a nickel-base alloy.

### Solution to Problem

In order to solve the above-described problem and achieve the object, a nickel-base alloy of the present invention includes at least one metal element among chromium, molybdenum, and niobium, nickel, aluminum, and carbon, and has crystal grains containing the nickel as a primary component, and carbides which are precipitated in crystal grain boundaries between the crystal grains, have a diameter of 0.1 μm or more and 10 μm or less, have an aspect ratio of 3 or more, and include the metal element and the carbon.

In the nickel-base alloy, since carbides which have a diameter of 0.1 μm or more and 10 μm or less, have an aspect ratio of 3 or more, and include a metal element and carbon are precipitated in crystal grain boundaries between crystal grains containing nickel as a primary component, and thus the crystal grain boundaries become strong, the high-temperature strength becomes high.

The nickel-base alloy of the present invention preferably further has metal precipitates which are precipitated in the crystal grain boundaries, have a diameter of 0.1 μm or more and 20 μm or less, have an aspect ratio of 3 or more, and include an alloy including the nickel or the niobium and the aluminum. In such a case, in the nickel-base alloy, the crystal grain boundaries further become strong, and thus the high-temperature strength further becomes high.

In the nickel-base alloy of the present invention, a content ratio of the aluminum is preferably 2% by mass or more and 7% by mass or less. In such a case, in the nickel-base alloy, it is possible to make the precipitation amount of precipitates in the crystal grain boundaries more appropriate, and it is possible to further increase the high-temperature strength.

In a turbine blade of the present invention, the nickel-base alloy of the present invention is preferably used. In such a case, in the turbine blade, the high-temperature strength becomes high.

A method for producing an injection molded article of a nickel-base alloy of the present invention has an injection molding step of injecting a powder material of a nickel-base alloy which includes at least one metal element among chromium, molybdenum, and niobium, nickel, aluminum, and carbon and has a grain size of 1 μm or more and 50 μm or less into a molding tool and forming an injection molded article, and a thermal treatment step of heating the injection molded article so as to crystallize an alloy containing the nickel as a primary component and generating a crystal structure having crystal grains containing the nickel as a primary component and carbides which are precipitated in crystal grain boundaries between the crystal grains, have a diameter of 0.1 μm or more and 10 μm or less, have an aspect ratio of 3 or more, and include the metal element and the carbon.

According to the method for producing an injection molded article of a nickel-base alloy, since it is possible to produce an injection molded article of a nickel-base alloy in which carbides which have a diameter of 0.1 μm or more and 10 μm or less, have an aspect ratio of 3 or more, and include a metal element and carbon are precipitated in crystal grain boundaries between crystal grains containing nickel as a primary component, it is possible to produce an injection molded article of a nickel-base alloy which has strong crystal grain boundaries, and it is possible to produce an injection molded article of a nickel-base alloy which has high high-temperature strength.

In the method for producing an injection molded article of a nickel-base alloy of the present invention, the thermal treatment step preferably further generates a crystal structure further having metal precipitates which are precipitated in the crystal grain boundaries, have a diameter of 0.1 μm or more and 20 μm or less, have an aspect ratio of 3 or more, and include an alloy including the nickel or the niobium and the aluminum. Since this method enables the production of an injection molded article of a nickel-base alloy in which crystal grain boundaries are stronger due to the metal precipitates, it is possible to produce an injection molded article of a nickel-base alloy which has higher high-temperature strength.

In the method for producing an injection molded article of a nickel-base alloy of the present invention, in the powder material of a nickel-base alloy, a content ratio of the aluminum is preferably 2% by mass or more and 7% by mass or less. In such a case, it is possible to produce an injection molded article of a nickel-base alloy which has higher high-temperature strength.

The method for producing an injection molded article of a nickel-base alloy of the present invention preferably further includes a step of melting and mixing a material of a nickel-base alloy including at least one metal element among chromium, molybdenum, and niobium, nickel, aluminum, and carbon so as to produce an ingot of the nickel-base alloy, and a step of heating a periphery of the ingot, melting a part of the ingot so as to generate liquid droplets of the nickel-base alloy, and blowing cooling gas to the liquid droplets so as to cool the liquid droplets, thereby producing a powder material of the nickel-base alloy. This method enables the stable production of an injection molded article of a nickel-base alloy having high high-temperature strength.

### Advantageous Effects of Invention

According to the present invention, it is possible to obtain a nickel-base alloy having high high-temperature strength.

### BRIEF DESCRIPTION OF DRAWINGS

FIG. 1 is a view illustrating an example of a crystal structure of a nickel-base alloy according to an embodiment of the present invention.

FIG. 2 is a view illustrating an example of a structure of a precipitate that is precipitated in a crystal grain boundary in the nickel-base alloy.

FIG. 3 is a view illustrating an example of a constitution of a device for producing an ingot of the nickel-base alloy.

FIG. 4 is a view illustrating an example of a constitution of a device for producing a powder material of the nickel-base alloy.

FIG. 5 is a flowchart illustrating an example of steps of a method for producing a nickel-base alloy.

FIG. 6 is a view illustrating an example of an SEM image of a cross section of an injection molded article of a nickel-base alloy of Example 1.

FIG. 7 is a view illustrating an enlarged SEM image of a portion in a dotted frame in the SEM image of FIG. 6.

FIG. 8 is a view illustrating an example of an image illustrating a result of an in-plane distribution measurement of a content ratio of aluminum in the same region as in the SEM image of FIG. 7 using an EPMA.

FIG. 9 is a view illustrating an example of an image illustrating a result of an in-plane distribution measurement of a content ratio of niobium in the same region as in the SEM image of FIG. 7 using the EPMA.

FIG. 10 is a view illustrating an example of an image illustrating a result of an in-plane distribution measurement of a content ratio of molybdenum in the same region as in the SEM image of FIG. 7 using the EPMA.

FIG. 11 is a graph illustrating measurement results of tensile strengths at high temperatures of injection molded articles of a nickel-base alloy of Example 1 and Comparative Example 1.

FIG. 12 is a view illustrating an example of an SEM image of a cross section of the injection molded article of a nickel-base alloy of Comparative Example 1.

FIG. 13 is a view illustrating an enlarged SEM image of a portion in a dotted frame in the SEM image of FIG. 12.

FIG. 14 is a view illustrating an example of an image illustrating a result of an in-plane distribution measurement of a content ratio of aluminum in the same region as in the SEM image of FIG. 13 using the EPMA.

FIG. 15 is a view illustrating an example of an image illustrating a result of an in-plane distribution measurement of a content ratio of niobium in the same region as in the SEM image of FIG. 13 using the EPMA.

FIG. 16 is a view illustrating an example of an image illustrating a result of an in-plane distribution measurement of a content ratio of molybdenum in the same region as in the SEM image of FIG. 13 using the EPMA.

### DESCRIPTION OF EMBODIMENTS

Hereinafter, a nickel-base alloy according to an embodiment of the present invention, a turbine blade using the nickel-base alloy, and a method for producing an injection molded article of the nickel-base alloy will be described in detail on the basis of drawings. Meanwhile, the embodiment described below does not limit the present invention and can be appropriately modified and carried out.

(Nickel-base alloy)

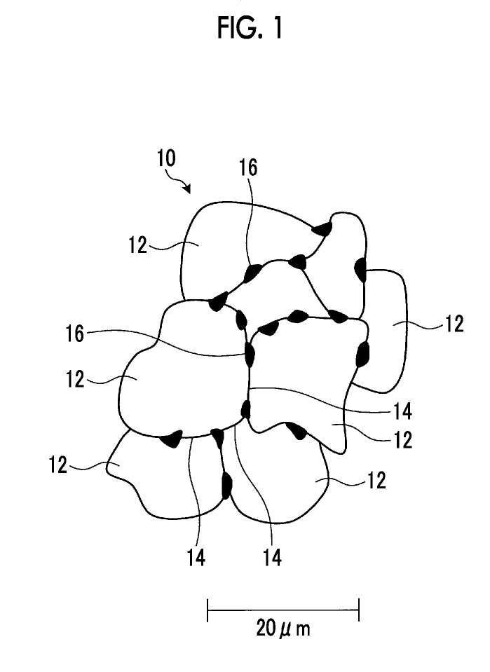

FIG. 1 is a view illustrating an example of the crystal structure of a nickel-base alloy 10 according to an embodiment of the present invention. Hereinafter, the nickel-base alloy 10 will be described using FIG. 1. The nickel-base alloy 10 includes at least one metal element among chromium (Cr), molybdenum (Mo), and niobium (Nb), nickel (Ni), aluminum (Al), carbon (C), and inevitable impurities. In the nickel-base alloy 10, nickel is the primary component.

In the nickel-base alloy 10, the content ratio of aluminum is preferably 2% by mass or more and 7% by mass or less. In the nickel-base alloy 10, the content ratio of chromium is preferably 10% by mass or more and 20% by mass or less. In the nickel-base alloy 10, the content ratio of molybdenum is preferably 1% by mass or more and 10% by mass or less. In the nickel-base alloy 10, the content ratio of niobium is preferably 1% by mass or more and 7% by mass or less. In the nickel-base alloy 10, the content ratio of carbon is preferably 0.01% by mass or more and 0.2% by mass or less. The nickel-base alloy 10 is preferably, for example, the same component as INCONEL713C (INCONEL is a registered trademark of No. 0298860) or INCONEL718 (INCONEL is a registered trademark).

Next, the crystal structure of the nickel-base alloy will be descried. The nickel-base alloy 10 has a plurality of crystal grains 12 and a plurality of precipitates 16. In the nickel-base alloy 10, portions between the crystal grains 12, that is, the boundaries between the respective crystal grains 12 become crystal grain boundaries 14. The crystal grain 12 is a crystal containing nickel as the primary component. The grain size of the crystal grain 12 is preferably 1 μm or more and 100 μm or less and more preferably 1 μm or more and 20 μm or less. Here, the grain size of the crystal grain 12 is obtained from the diameter of a circle having the same area as the cross-sectional area of the crystal grain 12 on a cross section of the nickel-base alloy 10.

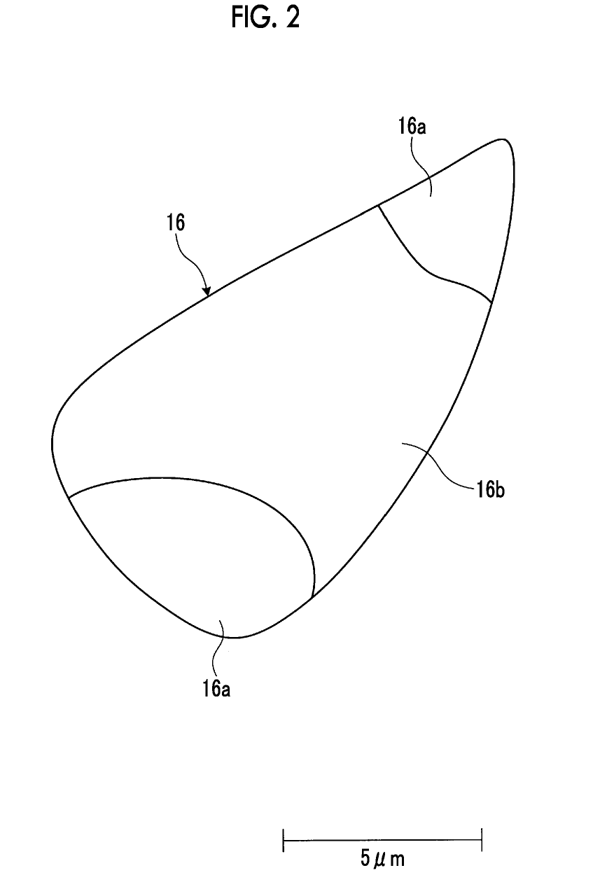

The precipitates 16 are precipitated in the crystal grain boundaries 14. The precipitates 16 are precipitated in a dotted fashion along the crystal grain boundaries 14 in a film shape. FIG. 2 is a view illustrating an example of the structure of the precipitate 16 that is precipitated in the crystal grain boundary 14 in the nickel-base alloy 10. The precipitate 16 has carbides 16a and a metal precipitate 16b. That is, the carbides 16a and the metal precipitate 16b are all precipitated in a dotted fashion along the crystal grain boundaries 14 in a film shape. The carbide 16a includes at least one metal element among chromium, molybdenum, and niobium and carbon.

The diameter of the carbide 16a is 0.1 μm or more and 10 μm or less, preferably 0.1 μm or more and 5 μm or less, and more preferably 0.1 μm or more and 2 μm or less. Here, the diameter of the carbide 16a is obtained from the diameter of a circle having the same area as the cross-sectional area of the carbide 16a on a cross section of the nickel-base alloy 10.

Since the carbides 16a are precipitated in a dotted fashion along the crystal grain boundaries 14 in a film shape, there are carbides having a high aspect ratio. The aspect ratio of the carbide 16a is 3 or more and preferably 3 or more and 20 or less. Here, the aspect ratio of the carbide 16a is obtained by approximating the cross section of the carbide 16a on a cross section of the nickel-base alloy 10 to an ellipse and obtaining the value of the ratio of the long diameter to the short diameter of the approximated ellipse, that is, (long diameter)/(short diameter).

The carbide 16a needs to include a part of at least one metal element among chromium, molybdenum, and niobium and a part of carbon. The crystal grain 12 may include a part of at least one metal element among chromium, molybdenum, and niobium or a part of carbon and may include a carbide having the same composition and constitution as the carbide 16a.

The metal precipitate 16b includes an alloy including nickel or niobium and aluminum. Examples of the metal precipitate 16b include a γ prime precipitate including Ni₃Al (trinickel aluminide), which is an alloy including nickel and aluminum, as the primary component and a γ double prime precipitate including Nb₃Al (triniobium aluminide), which is an alloy including niobium and aluminum, as the primary component. As the metal precipitate 16b, any one of the γ prime precipitate and the γ double prime precipitate is precipitated in the crystal grain boundary 14 depending on the content ratios of the respective elements of the nickel-base alloy 10. In a case in which the content ratio of aluminum is high and the content ratio of niobium is low in the nickel-base alloy 10 as exemplified in INCONEL713C (INCONEL is a registered trademark), the metal precipitate 16b is the γ prime precipitate. In a case in which the content ratio of aluminum is low and the content ratio of niobium is high in the nickel-base alloy 10 as exemplified in INCONEL718 (INCONEL is a registered trademark), the metal precipitate 16b is the γ double prime precipitate. Hereinafter, a case in which the metal precipitate 16b is the γ prime precipitate will be described, but the description is also true in a case in which the metal precipitate 16b is the γ double prime precipitate.

The diameter of the metal precipitate 16b is 0.1 μm or more and 20 μm or less and preferably 0.1 μm or more and 10 μm or less. Here, the diameter of the metal precipitate 16b is obtained from the diameter of a circle having the same area as the cross-sectional area of the metal precipitate 16b on a cross section of the nickel-base alloy 10.

Since the metal precipitates 16b are precipitated in a dotted fashion along the crystal grain boundaries 14 in a film shape, there are metal precipitates having a low aspect ratio. The aspect ratio of the metal precipitate 16b is 3 or more and preferably 3 or more and 20 or less. Here, the aspect ratio of the metal precipitate 16b is obtained by approximating the cross section of the metal precipitate 16b on a cross section of the nickel-base alloy 10 to an ellipse and obtaining the value of the ratio of the long diameter to the short diameter of the approximated ellipse, that is, (long diameter)/(short diameter).

The metal precipitate 16b needs to include a part of nickel or niobium and a part of aluminum. The crystal grain 12 may include a part of nickel or niobium or a part of aluminum and may include a metal precipitate having the same composition and constitution as the metal precipitate 16b.

In the nickel-base alloy 10, since the carbides 16a are precipitated in the crystal grain boundaries 14, the crystal grain boundaries 14 are strong. Therefore, in the nickel-base alloy 10, the high-temperature strength is high, that is, the tensile strength at a high temperature is high, and the creep characteristic at a high temperature is favorable. In addition, in the nickel-base alloy 10, since the carbides 16a are precipitated in a dotted fashion along the crystal grain boundaries 14 in a film shape, the crystal grain boundaries 14 do not become brittle even at a high temperature and are persistent. In addition, the elongation of the nickel-base alloy 10 at a high temperature decreases, and it becomes difficult for the nickel-base alloy to elongate at a high temperature.

Furthermore, in the nickel-base alloy 10, the metal precipitates 16b are precipitated in the crystal grain boundaries 14 and thus suppress the slip or dislocation of the nickel-base alloy 10, that is, the nickel-base alloy is precipitation-cured, whereby the crystal grain boundaries 14 become stronger. Therefore, in the nickel-base alloy 10, the high-temperature strength becomes higher, that is, the tensile strength at a high temperature does not become higher, and the creep characteristic at a high temperature becomes more favorable. In addition, in the nickel-base alloy 10, since the metal precipitates 16b are precipitated in a dotted fashion along the crystal grain boundaries 14 in a film shape, the crystal grain boundaries 14 do not become brittle even at a high temperature and become more persistent. In addition, the elongation of the nickel-base alloy 10 at a high temperature further decreases, and it becomes more difficult for the nickel-base alloy to elongate at a high temperature.

In the nickel-base alloy 10, the content ratio of aluminum is preferably set to 1% by mass or more. When the content ratio of aluminum is set to 1% by mass or more in the nickel-base alloy 10, it is possible to make the precipitation amount of precipitates in the crystal grain boundaries appropriate, and it is possible to increase the high-temperature strength. In the nickel-base alloy 10, the content ratio of aluminum is more preferably set to 2% by mass or more. When the content ratio of aluminum is set to 2% by mass or more in the nickel-base alloy 10, it is possible to make the precipitation amount of precipitates in the crystal grain boundaries more appropriate, and it is possible to further increase the high-temperature strength.

(Turbine Blade)

A turbine blade according to an embodiment of the present invention is an example of an injection molded article in which the nickel-base alloy according to the embodiment of the present invention is used. The turbine blade according to an embodiment of the present invention is a turbine blade that is used for members that are used in high-temperature environments, for example, gas turbines such as aircraft engines or motors or turbochargers, and the nickel-base alloy 10 according to the embodiment of the present invention is preferably used as a material. In the turbine blade in which the nickel-base alloy 10 according to the embodiment of the present invention is used, since the crystal grain boundaries 14 in the nickel-base alloy 10 that is used as a material are strong, the high-temperature strength is high, that is, the tensile strength at a high temperature is high, and the creep characteristic at a high temperature is favorable. In addition, the turbine blade in which the nickel-base alloy 10 is used does not become brittle even at a high temperature and is persistent. In addition, the elongation of the turbine blade in which the nickel-base alloy 10 is used at a high temperature decreases, and it becomes difficult for the turbine blade to elongate at a high temperature.

(Method for Producing Injection Molded Article of Nickel-Base Alloy)

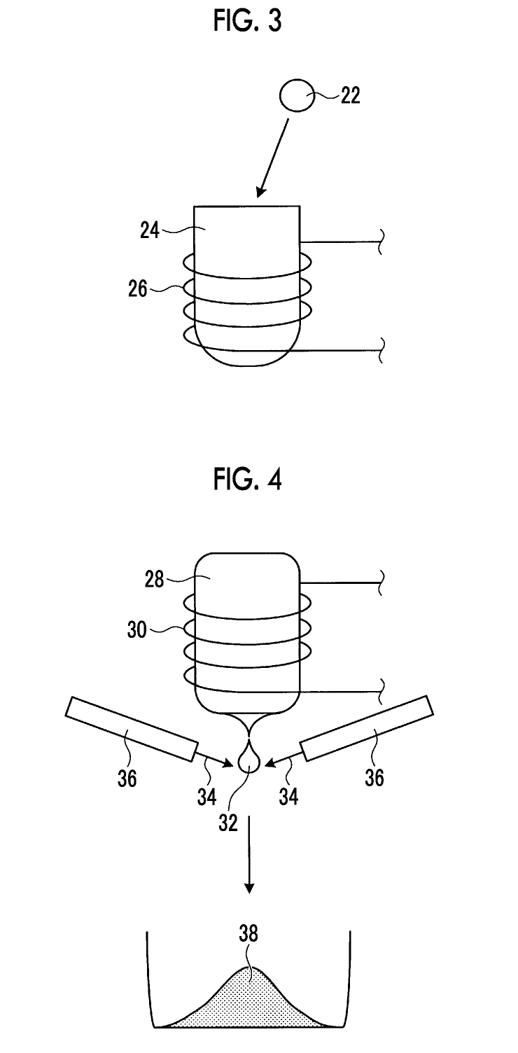

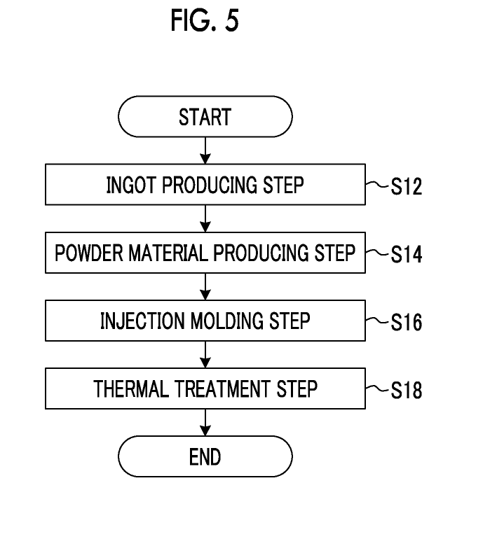

FIG. 3 is a view illustrating an example of the constitution of a device for producing an ingot 28 of the nickel-base alloy. FIG. 4 is a view illustrating an example of the constitution of a device for producing a powder material 38 of the nickel-base alloy. FIG. 5 is a flowchart illustrating an example of steps of a method for producing an injection molded article of the nickel-base alloy. Hereinafter, the method for producing an injection molded article of the nickel-base alloy will be described using FIGS. 3, 4, and 5. Here, the respective devices illustrated in FIGS. 3 and 4 may be fully automatically operated or may be operated by an operator's operation. In addition, the treatment illustrated in FIG. 5 may be fully automatically carried out or may be carried out by an operator's operation in each step. The scope of the production device and the production method of the present embodiment includes devices and methods relating to metal injection molding (MIM), and thus a molding tool is used. The molding tool may have been produced in advance or may be produced each time MIM is carried out.

The device for producing the ingot 28 of the nickel-base alloy illustrated in FIG. 3 is an example of a device for carrying out an ingot producing step of Step S12 in FIG. 5 using a so-called induction melting method and has a refractory crucible 24 into which a material 22 of the nickel-base alloy is injected and a coil 26 spirally wound around the refractory crucible 24. The material 22 is a material prepared so as to obtain the same range of composition as the nickel-base alloy 10 and includes at least one metal element among chromium, molybdenum, and niobium, nickel, aluminum, carbon, and inevitable impurities. The coil 26 is connected to an alternating power supply at both ends and allows the flow of alternating current.

When alternating current is caused to flow through the coil, the coil 26 generates a magnetic field in the refractory crucible 24. In addition, the material 22 that has been injected into the refractory crucible 24 is electromagnetically induced by the magnetic field generated in the refractory crucible 24, and current flows in the material. In addition, the material 22 in which current flows generates heat due to the intrinsic electrical resistance of the material 22. As a result, the material 22 melts and mixes together.

When the flow of the alternating current in the coil is stopped, the magnetic field generated in the refractory crucible 24 disappears. In addition, the electromagnetic induction of the material 22 in the refractory crucible 24 by the magnetic field generated in the refractory crucible 24 ends, and the current in the material disappears. In addition, the heat generation of the material 22 ends. As time elapses in a state in which the heat generation has ended, the material 22 in the refractory crucible 24 naturally cools, solidifies, and turns into the ingot 28 of the nickel-base alloy having the same range of composition as the nickel-base alloy 10. As described above, the device for producing the ingot 28 of the nickel-base alloy is capable of producing the ingot 28 of the nickel-base alloy having the same range of composition as the nickel-base alloy 10 from the material 22 of the nickel-base alloy prepared so as to obtain the same range of composition as the nickel-base alloy 10.

The device for producing the powder material 38 of the nickel-base alloy illustrated in FIG. 4 is an example of a device for carrying out a powder material producing step of Step S14 in FIG. 5 using a so-called atomizing method and has a mechanism that disposes the ingot 28 of the nickel-base alloy, a coil 30 spirally wound around the disposed ingot 28, and a cooling gas blowing portion 36 that blows cooling gas 34 to liquid droplets 32 of the nickel-base alloy which are generated from a lower side portion of the ingot 28 in the vertical direction. The ingot 28 has the same range of composition as the nickel-base alloy 10 and includes at least one metal element among chromium, molybdenum, and niobium, nickel, aluminum, carbon, and inevitable impurities. The coil 30 is connected to an alternating power supply at both ends and allows the flow of alternating current. As the cooling gas 34, a gas that does not chemically react with the nickel-base alloy, for example, noble gas such as argon gas is preferably exemplified, but the cooling gas is not limited thereto.

When alternating current is caused to flow through the coil, the coil 30 generates a magnetic field in the periphery of the ingot 28. In addition, the ingot 28 is electromagnetically induced by the magnetic field generated in the ingot, and current flows in the periphery. In addition, the ingot 28 in which current flows in the periphery generates heat due to the intrinsic electrical resistance of the ingot 28. As a result, the peripheral portion of the ingot 28 is heated, a part of the peripheral portion melts, and the liquid droplets 32 of the nickel-base alloy that drop downwards from the lower side portion in the vertical direction are generated.

The liquid droplets 32 generated from the ingot 28 are cooled by the cooling gas 34 blown from the cooling gas blowing portion 36, turned into powder having a small grain size, accumulated below, and turned into the powder material 38 of the nickel-base alloy having the same range of composition as the nickel-base alloy 10. The powder material 38 produced in the powder material producing step of Step S14 has the same range of composition as the nickel-base alloy 10 and includes at least one metal element among chromium, molybdenum, and niobium, nickel, aluminum, carbon, and inevitable impurities. As described above, the device for producing the powder material 38 of the nickel-base alloy is capable of producing the powder material 38 of the nickel-base alloy having the same range of composition as the nickel-base alloy 10 from the ingot of the nickel-base alloy having the same range of composition as the nickel-base alloy 10. The powder material 38 of the nickel-base alloy is produced using the above-described method and is thus produced to have a grain size of 1 μm or more and 50 μm or less and preferably 1 μm or more and 20 μm or less.

A method for producing an injection molded article of the nickel-base alloy of the present embodiment includes the ingot producing step S12, the powder material producing step S14, an injection molding step S16, and a thermal treatment step S18. The ingot producing step S12 is a step for producing the ingot 28 of the nickel-base alloy having the same range of composition as the nickel-base alloy 10 from the material 22 of the nickel-base alloy prepared so as to obtain the same range of composition as the nickel-base alloy 10 as described above using, for example, the device for producing the ingot 28 of the nickel-base alloy illustrated in FIG. 3. The powder material producing step S14 is a step for producing the powder material 38 of the nickel-base alloy having the same range of composition as the nickel-base alloy 10 from the ingot 28 of the nickel-base alloy prepared so as to obtain the same range of composition as the nickel-base alloy 10 as described above using, for example, the device for producing the powder material 38 of the nickel-base alloy illustrated in FIG. 4.

The injection molding step S16 is a step of injecting the powder material 38 of the nickel-base alloy produced in the powder material producing step S14 into a molding tool and forming an injection molded article, that is, a step relating to MIM. In a case in which the shape of the molding tool is complicate, the injection molding step S16 is carried out at an increased injection pressure of the powder material 38 of the nickel-base alloy.

The thermal treatment step S18 is a step of heating the injection molded article formed in the injection molding step S16 so as to crystallize powder particles (a particulate alloy) containing the nickel as the primary component and generating a crystal structure having crystal grains containing nickel as the primary component and carbides which are precipitated in crystal grain boundaries between the crystal grains and include at least one metal element among chromium, molybdenum, and niobium and the carbon. In addition, in the thermal treatment step S18, a defatting treatment that removes a binder mixed into the powder material during the injection molding is also carried out. The ranges of the diameter and aspect ratio of the carbide that is precipitated in the crystal grain boundary are the same as the ranges of the diameter and aspect ratio of the carbide 16a in the nickel-base alloy 10. The range of the grain size of the crystal grain containing nickel as the primary component is the same as the preferred range of the grain size of the crystal grain 12 in the nickel-base alloy 10.

The thermal treatment step S18 preferably further generates a crystal structure further having metal precipitates which are precipitated in the crystal grain boundaries of the crystal grains containing nickel as the primary component and include an alloy including nickel or niobium and aluminum. The ranges of the diameter and aspect ratio of the metal precipitate that is precipitated in the crystal grain boundary are the same as the ranges of the diameter and aspect ratio of the metal precipitate 16b in the nickel-base alloy 10.

In the method for producing an injection molded article of a nickel-base alloy according to the present embodiment, the powder material 38 is molded along the molding tool in the injection molding step S16 and is then sintered in the thermal treatment step S18. Therefore, unlike a casting method, a molten material is not injected into a casting die, particles are closely packed and then sintered by carrying out a thermal treatment. Therefore, in the produced injection molded article of a nickel-base alloy, compared with a casting molded article formed using a casting method, the grain diameter of the crystal grain containing nickel as the primary component is small, and it is possible to set the grain size to, for example, preferably 1 μm or more and 50 μm or less and more preferably 1 μm or more and 20 μm or less.

In addition, in the injection molded article formed in the injection molding step S16, the carbides including chromium, molybdenum, and niobium and carbon are dissolved in the respective powder particles, present in a distributed fashion, and held in a state in which the carbides solidify and are not precipitated. That is, the injection molded article formed in the injection molding step S16 is held in a state in which it is possible to finely control the precipitation state of the carbides including chromium, molybdenum, and niobium and carbon using the injection molding step S16 and the following step. Furthermore, in the injection molded article formed in the injection molding step S16, the metal precipitates are dissolved in the respective powder particles and present in a distributed fashion. That is, the injection molded article formed in the injection molding step S16 is held in a state in which it is possible to finely control the precipitation state of the metal precipitates using the injection molding step S16 and the following step.

In the method for producing an injection molded article of a nickel-base alloy according to the present embodiment, in the thermal treatment step S18, it is possible to finely control the precipitation state of the carbides so that the carbides become the same structure as the carbides 16a in the nickel-base alloy 10. Specifically, the state of the precipitates that are precipitated in the crystal grain boundaries can be controlled by controlling the temperature or time of the thermal treatment. Therefore, the method for producing an injection molded article of a nickel-base alloy according to the present embodiment enables the production of an injection molded article in which a nickel-base alloy having strong crystal grain boundaries as exemplified as the nickel-base alloy 10 in which the carbides 16a are precipitated in the crystal grain boundaries 14 is used. Furthermore, in the method for producing an injection molded article of a nickel-base alloy according to the present embodiment, it is possible to finely control the precipitation state of the metal precipitates so that the metal precipitates become the same structure as the metal precipitates 16b in the nickel-base alloy 10. Therefore, the method for producing an injection molded article of a nickel-base alloy according to the present embodiment enables the production of an injection molded article in which a nickel-base alloy having stronger crystal grain boundaries as exemplified as the nickel-base alloy 10 in which the metal precipitates 16b are further precipitated in the crystal grain boundaries 14 is used.

The method for producing an injection molded article of a nickel-base alloy according to the present embodiment enables the production of an injection molded article having high high-temperature strength in which a nickel-base alloy having strong crystal grain boundaries as exemplified as the nickel-base alloy 10 is used. That is, the method for producing an injection molded article of a nickel-base alloy according to the present embodiment enables the production of an injection molded article in which the tensile strength at a high temperature is high and the creep characteristic at a high temperature is favorable. In addition, the method for producing an injection molded article of a nickel-base alloy according to the present embodiment enables the production of an injection molded article which does not become brittle even at a high temperature and is persistent. In addition, the method for producing an injection molded article of a nickel-base alloy according to the present embodiment enables the production of an injection molded article in which the elongation at a high temperature decreases and it is difficult for the injection molded article to elongate at a high temperature.

In the nickel-base alloy, the content ratio of aluminum is preferably set to 1% by mass or more. The method for producing an injection molded article of a nickel-base alloy according to the present embodiment enables the strengthening of the crystal grain boundaries and the production of an injection molded article having high high-temperature strength even in a case in which the content ratio of aluminum is 1% by mass or more. In the nickel-base alloy, the content ratio of aluminum is more preferably set to 2% by mass or more. The method for producing an injection molded article of a nickel-base alloy according to the present embodiment enables the strengthening of the crystal grains and the production of an injection molded article having high high-temperature strength even in a case in which the content ratio of aluminum is 2% by mass or more.

Meanwhile, in the method for producing an injection molded article of a nickel-base alloy according to the present embodiment, the material 22 of the nickel-base alloy prepared so as to obtain the same range of composition as the nickel-base alloy 10 is selected as the initial material, but it is also allowed to select the ingot 28 of a nickel-base alloy having the same range of composition as the nickel-base alloy 10 as the initial material and carry out only the powder material producing step S14 and the following treatments without carrying out the treatment of the ingot producing step S12.

### EXAMPLES

Hereinafter, the present invention will be described in more detail on the basis of examples carried out to clarify the effects of the present invention. Meanwhile, the present invention is not limited by the following examples.

### Example 1

The same treatment as the ingot producing step S12 was carried out on a material of a nickel-base alloy having almost the same composition as INCONEL713C (INCONEL is a registered trademark), that is, including 6.1% by mass of aluminum, 13% by mass of chromium, 4.5% by mass of molybdenum, 2.3% by mass of niobium, and 0.14% by mass of carbon so as to produce the ingot 28 of the nickel-base alloy, and the same treatment as the powder material producing step S14 was carried out on the ingot of the nickel-base alloy so as to produce the powder material 38 of the nickel-base alloy. After that, the same treatment as the injection molding step S16 was carried out on the powder material 38 of the nickel-base alloy so as to form an injection molded article. The same treatment as the thermal treatment step S18 was carried out on the injection molded article, thereby producing the injection molded article of a nickel-base alloy according to the embodiment of the present invention. The injection molded article of a nickel-base alloy produced using the method for producing an injection molded article of a nickel-base alloy according to the embodiment of the present invention was considered as an injection molded article of Example 1.

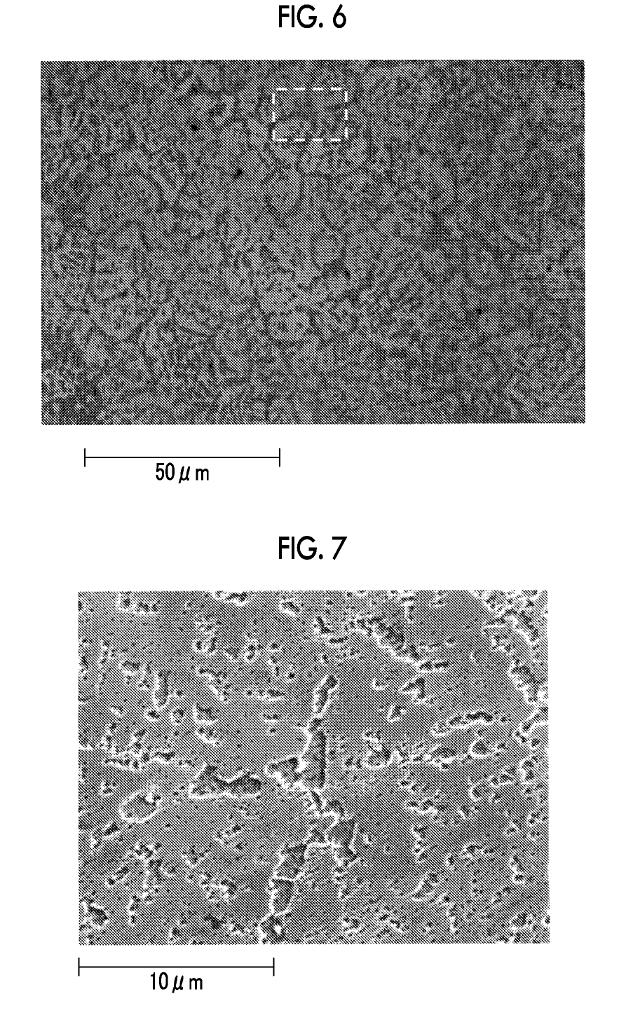

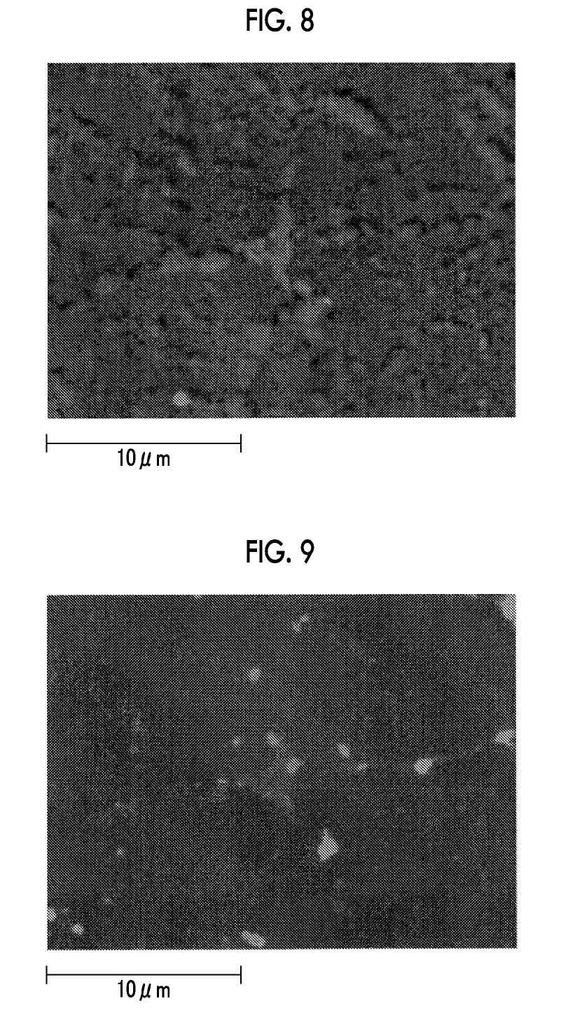

A cross section of the injection molded article of Example 1 was observed and captured using a scanning electron microscope (SEM), thereby acquiring an SEM image of Example 1. The SEM observation and capturing were carried out using SS-550 manufactured by Shimadzu Corporation at an accelerated voltage set to 15 kV. The SEM image of Example 1 is illustrated in FIGS. 6 and 7. In addition, EPMA images of Example 1 were respectively acquired by measuring the in-plane distributions of the content ratios of individual elements of aluminum, niobium, and molybdenum in a cross section of the injection molded article of Example 1 using an electron probe microanalyser (EPMA) and expressing the in-plane distributions using contrasting densities. Regarding the measurement conditions of the EPMA, EPMA-1720 manufactured by Horiba Ltd. was used, the accelerated voltage was set to 15 kV, and the diameter of the electron beam was made to converge toward 0.1 μm. The respective EPMA images of Example 1 are respectively illustrated in FIGS. 8, 9, and 10. In the respective EPMA images of Example 1, light-colored places are places in which the content ratios of the respective elements are higher than those in deep-colored places. In addition, individual tensile strengths at a plurality of temperatures in a range of 650° C. or higher and 900° C. or lower were measured using round bar tensile test specimens of American Society for Testing and Materials ASTM E8 sampled from an arbitrary location of the injection molded article of Example 1 according to the standard test methods for elevated temperature tension tests of metallic materials specified by ASTM E21. The measurement results of the respective tensile strengths of Example 1 were illustrated in FIG. 11.

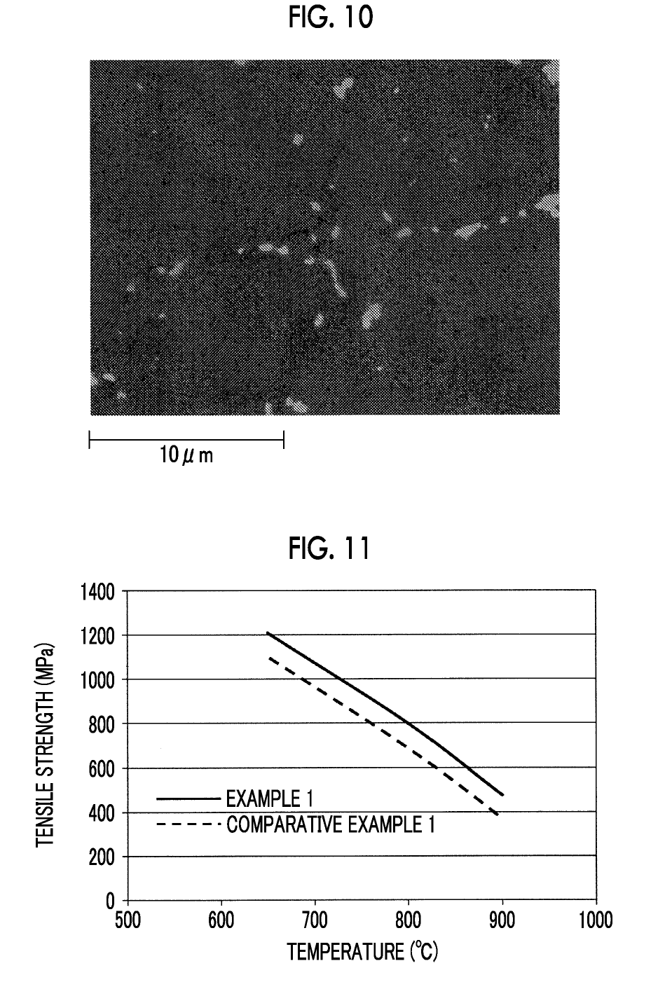

FIG. 6 is an example of the SEM image of the cross section of the injection molded article of the nickel-base alloy of Example 1. FIG. 7 is an enlarged SEM image of a portion in a dotted frame in the SEM image of FIG. 6. FIG. 8 is an example of an image illustrating the result of the in-plane distribution measurement of the content ratio of aluminum in the same region as in the SEM image of FIG. 7 using the EPMA. FIG. 9 is an example of an image illustrating the result of the in-plane distribution measurement of the content ratio of niobium in the same region as in the SEM image of FIG. 7 using the EPMA. FIG. 10 is an example of an image illustrating the result of the in-plane distribution measurement of the content ratio of molybdenum in the same region as in the SEM image of FIG. 7 using the EPMA. FIG. 11 is a graph illustrating the measurement results of the tensile strengths at high temperatures of injection molded articles of a nickel-base alloy of Example 1 and Comparative Example 1.

From the SEM images of Example 1 illustrated in FIGS. 6 and 7, it was found that, in the injection molded article of Example 1 produced using the method for producing an injection molded article of a nickel-base alloy according to the present embodiment, the grain size of a plurality of crystal grains containing nickel as the primary component was 1 μm or more and 20 μm or less.

From the EPMA image of Example 1 illustrated in FIG. 8, it was found that, in the injection molded article of Example 1, aluminum was present in a dotted fashion in a film shape along the crystal grain boundaries of the plurality of crystal grains containing nickel as the primary component in a shape having a diameter of 0.1 μm or more and 20 μm or less and an aspect ratio of 3 or more. From the above-described finding, it is assumed that the injection molded article of Example 1 has γ prime precipitates that are metal precipitates which are precipitated in the crystal grain boundaries of the plurality of crystal grains containing nickel as the primary component, have a diameter of 0.1 μm or more and 20 μm or less, have an aspect ratio of 3 or more, and include an alloy including nickel and aluminum.

From the EPMA images of Example 1 illustrated in FIGS. 9 and 10, it was found that, in the injection molded article of Example 1, niobium and molybdenum were present in a dotted fashion in a film shape along the crystal grain boundaries of the plurality of crystal grains containing nickel as the primary component in a shape having a grain size of 0.1 μm or more and 10 μm or less and an aspect ratio of 3 or more. From the above-described finding, it is assumed that the injection molded article of Example 1 has carbides which are precipitated in the crystal grain boundaries of the plurality of crystal grains containing nickel as the primary component, have a diameter of 0.1 μm or more and 20 μm or less, have an aspect ratio of 3 or more, and include niobium or molybdenum and carbon.

### Comparative Example 1

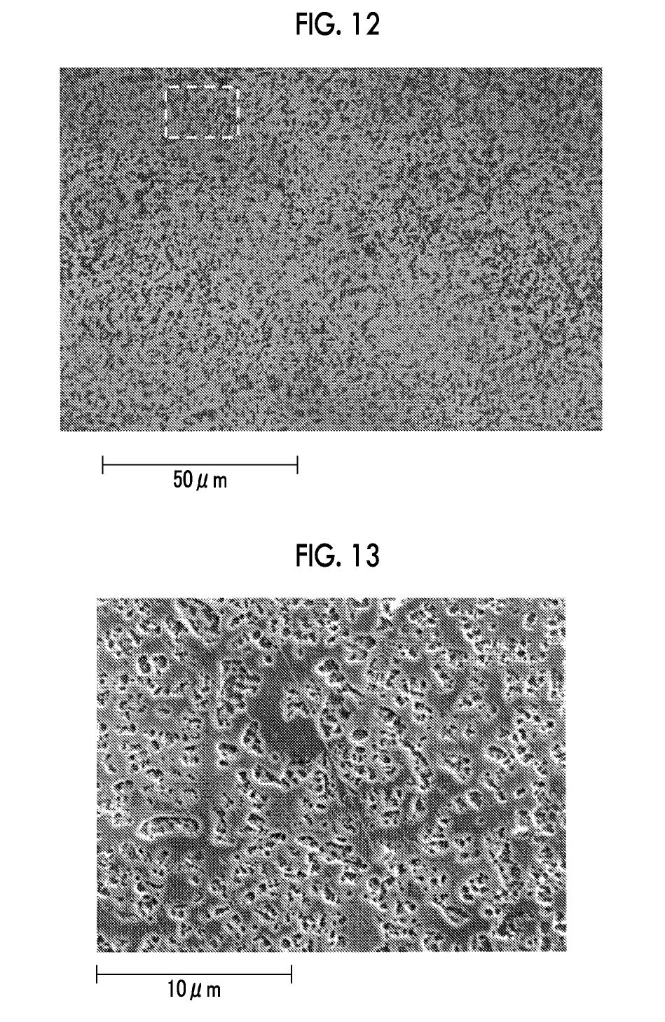

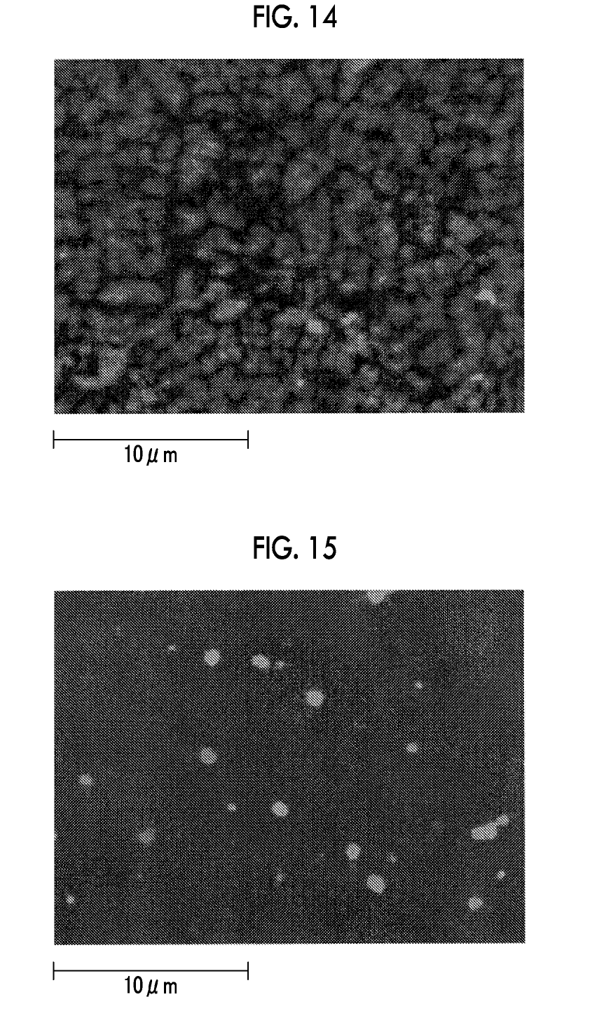

The injection molded article in a state of before the treatment of the thermal treatment step S18 in Example 1 was considered as an injection molded article of Comparative Example 1. A cross section of the injection molded article of Comparative Example 1 was observed and captured using an SEM under the same conditions as in Example 1, thereby acquiring SEM images of Comparative Example 1. The SEM images of Comparative Example 1 are illustrated in FIGS. 12 and 13. In addition, EPMA images of Comparative Example 1 were respectively acquired by measuring the in-plane distributions of the content ratios of individual elements of aluminum, niobium, and molybdenum in a cross section of the injection molded article of Comparative Example 1 using the EPMA under the same conditions as in Example 1 and expressing the in-plane distributions using contrasting densities. The respective EPMA images of Comparative Example 1 are respectively illustrated in FIGS. 14, 15, and 16. In the respective EPMA images of Comparative Example 1, similar to the respective EPMA images of Example 1, light-colored places are places in which the content ratios of the respective elements are higher than those in deep-colored places. In addition, individual tensile strengths at a plurality of temperatures in a range of 650° C. or higher and 900° C. or lower were measured using round bar tensile test specimens of American Society for Testing and Materials ASTM E8 sampled from an arbitrary location of the injection molded article of Comparative Example 1 according to the standard test methods for elevated temperature tension tests of metallic materials specified by ASTM E21. The measurement results of the respective tensile strengths of Comparative Example 1 were illustrated in FIG. 11 together with the measurement results of the respective tensile strengths of Example 1.

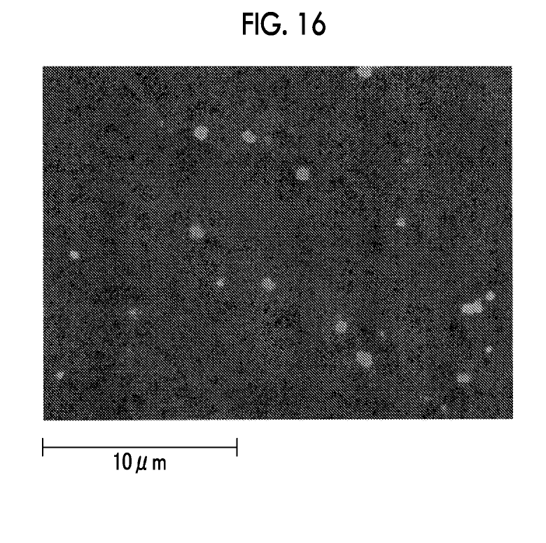

FIG. 12 is an example of the SEM image of the cross section of the injection molded article of a nickel-base alloy of Comparative Example 1. FIG. 13 is an enlarged SEM image of a portion in a dotted frame which corresponds to a region in which the crystal grain boundaries intersect each other in the SEM image of FIG. 12. FIG. 14 is an example of an image illustrating the result of the in-plane distribution measurement of the content ratio of aluminum in the same region as in the SEM image of FIG. 13 using the EPMA. FIG. 15 is an example of an image illustrating the result of the in-plane distribution measurement of the content ratio of niobium in the same region as in the SEM image of FIG. 13 using the EPMA. FIG. 16 is an example of an image illustrating the result of the in-plane distribution measurement of the content ratio of molybdenum in the same region as in the SEM image of FIG. 13 using the EPMA.

From the SEM images of Comparative Example 1 illustrated in FIGS. 12 and 13, it was found that, in the injection molded article of Comparative Example 1, the grain size of the crystal grains formed of powder particles containing nickel as the primary component being closely packed was maintained to be as small as 1 μm or more and 20 μm or less. In addition, from the EPMA images of Comparative Example 1 illustrated in FIGS. 14, 15, and 16, it was found that, in the injection molded article of Comparative Example 1, aluminum, niobium, and molybdenum were present in a distributed fashion in the respective crystal grains. From the above-described finding, it is assumed that the injection molded article of Comparative Example 1 is in a state in which carbon is not present in a solidified state and thus it is difficult to measure the content ratio using the EPMA, that is, a state in which the carbides are not precipitated in a solidified form.

From the respective EPMA images illustrated in FIGS. 9, 10, 15, and 16, it is assumed that, through the treatment of the thermal treatment step S18 according to the present embodiment, the injection molded article of Comparative Example 1 turns into a state of the injection molded article of Example 1, that is, has carbides which are precipitated in the crystal grain boundaries of the plurality of crystal grains containing nickel as the primary component, have a diameter of 0.1 μm or more and 10 μm or less, have an aspect ratio of 3 or more, and include niobium or molybdenum and carbon.

From the respective EPMA images illustrated in FIGS. 8 and 14, it is assumed that, through the treatment of the thermal treatment step S18 according to the present embodiment, the injection molded article of Comparative Example 1 turns into a state of the injection molded article of Example 1, that is, has γ prime precipitates that are metal precipitates which are precipitated in the crystal grain boundaries of the plurality of crystal grains containing nickel as the primary component, have a diameter of 0.1 μm or more and 20 μm or less, have an aspect ratio of 3 or more, and include an alloy including nickel and aluminum.

From the graph illustrated in FIG. 11, it was found that the tensile strength of Example 1 was approximately 1,200 MPa at 650° C., monotonously decreased as the temperature increased, and was approximately 500 MPa at 900° C. In addition, from the same graph, it was found that the tensile strength of Comparative Example 1 was approximately 1,100 MPa at 650° C., monotonously decreased as the temperature increased, and was approximately 400 MPa at 900° C. It was found that the tensile strength of Example 1 was higher than the high-temperature tensile strength of Comparative Example 1 in a range of 650° C. or higher and 900° C. or lower. That is, it was found that the tensile strength at a high temperature of the injection molded article of the nickel-base alloy improved through the treatment of the thermal treatment step S18 according to the present embodiment.

From what has been described above, it is assumed that, through the treatment of the thermal treatment step S18 according to the present embodiment, the injection molded article of a nickel-base alloy of Example 1 has carbides and γ prime precipitates which are precipitated in the crystal grain boundaries of the plurality of crystal grains containing nickel as the primary component and have a diameter and an aspect ratio in the above-described ranges, and thus the tensile strength at a high temperature increases.

### REFERENCE SIGNS LIST

10 NICKEL-BASE ALLOY

12 CRYSTAL GRAIN

14 CRYSTAL GRAIN BOUNDARY

16 PRECIPITATE

16a CARBIDE

16b METAL PRECIPITATE

22 MATERIAL

24 REFRACTORY CRUCIBLE

26, 30 COIL

28 INGOT

32 LIQUID DROPLET

34 COOLING GAS

36 COOLING GAS BLOWING PORTION

38 POWDER MATERIAL

1. A nickel-base alloy comprising:
at least one metal element selected from the group consisting of chromium, molybdenum, and niobium;
nickel;
aluminum; and
carbon,
wherein the nickel-base alloy has crystal grains containing the nickel as a primary component, and
carbides which are precipitated in crystal grain boundaries between the crystal grains, have a diameter of 0.1 μm or more and 10 μm or less, have an aspect ratio of 3 or more, and include the metal element and the carbon.

2. The nickel-base alloy according to claim 1, further comprising:
metal precipitates which are precipitated in the crystal grain boundaries, have a diameter of 0.1 μm or more and 20 μm or less, have an aspect ratio of 3 or more, and include an alloy including the nickel or the niobium and the aluminum.

3. The nickel-base alloy according to claim 1,
wherein a content ratio of the aluminum is 2% by mass or more and 7% by mass or less.

4. A turbine blade in which the nickel-base alloy according to claim 1 is used.

5. A method for producing an injection molded article of a nickel-base alloy, comprising:
injecting a powder material of a nickel-base alloy which includes at least one metal element selected from the group consisting of chromium, molybdenum, and niobium, nickel, aluminum, and carbon and has a grain size of 1 μm or more and 50 μm or less into a molding tool and forming to form an injection molded article; and
heating the injection molded article to crystallize an alloy containing the nickel as a primary component so that a crystal structure having crystal grains and carbides is generated, the crystal grains containing the nickel as a primary component, the carbides being precipitated in crystal grain boundaries between the crystal grains, the carbides having a diameter of 0.1 μm or more and 10 μm or less, having an aspect ratio of 3 or more, and including include the metal element and the carbon.

6. The method for producing an injection molded article of a nickel-base alloy according to claim 5,
wherein in the heating, a crystal structure further having metal precipitates is generated, the metal precipitates being precipitated in the crystal grain boundaries, having a diameter of 0.1 μm or more and 20 μm or less, having an aspect ratio of 3 or more, and including an alloy including the nickel or the niobium and the aluminum.

7. The method for producing an injection molded article of a nickel-base alloy according to claim 5,
wherein, in the powder material of a nickel-base alloy, a content ratio of the aluminum is 2% by mass or more and 7% by mass or less.

8. The method for producing an injection molded article of a nickel-base alloy according to claim 5, further comprising:
melting and mixing at least one metal element selected from the group consisting of chromium, molybdenum, and niobium, nickel, aluminum, and carbon to produce an ingot of the nickel-base alloy; and
heating a periphery of the ingot to melt a part of the ingot so that liquid droplets of the nickel-base alloy are generated, and blowing cooling gas to the liquid droplets to cool the liquid droplets so that a powder material of the nickel-base alloy is produced.
